(19) United States
(12) Patent Application Publication
(10) Pub. No.: US 2019/0240687 A1
(43) Pub. Date: Aug. 8, 2019

(54) MANUALLY-OPERATED SPRAY PUMP HAVING SELF-SEALING NOZZLE

(71) Applicant: CHONG WOO CO., LTD., Incheon (KR)

(72) Inventor: Chung Kee LEE, Seoul (KR)

(73) Assignee: CHONG WOO CO., LTD., Incheon (KR)

(21) Appl. No.: 16/342,743

(22) PCT Filed: Jan. 3, 2018
(86) PCT No.: PCT/KR2018/000081

§ 371 Date: Apr. 17, 2019

(30) Foreign Application Priority Data
Feb. 17, 2017 (KR) 20-2017-0000803

(51) Int. Cl. B05B 11/00; B05B 12/00

(52) U.S. Cl. CPC B05B 11/305; B05B 11/3026; B05B 12/002; B05B 11/3073; B05B 11/3025

(57) ABSTRACT

The present invention provides a manually-operated spray pump for discharging a predetermined amount of content by downwardly pressing a manually-operated button having a nozzle, and sealing the content therein by blocking a passage of the nozzle after discharge, wherein the manually-operated button comprises: a button main body coupled to a pump main body so as to communicate with a flow passage of the pump main body, and having an opening, which communicates with the flow passage so as to lead to the outside, formed on the outer surface at one side thereof; an elastic opening-and-closing member mounted on the flow passage of the opening, and opening the opening only when the content is discharged and closing the opening before and after discharge; and a cap member for mounting the elastic opening-and-closing member in position in the opening of the button main body.

### TECHNICAL FIELD

The present invention relates to a manual spray pump having a self-sealing nozzle, and more particularly to a manual spray pump, which is operated in such a manner that a manual button having a nozzle is pressed downwards to discharge a predetermined amount of content and then a passage in the nozzle is closed to seal the content, the manual button including a button body coupled to a pump body so as to communicate with a flow passage of the pump body, the button body having an opening formed in an outer surface of a portion thereof, the opening communicating with the flow passage and with an outside, an elastic opening-and-closing member disposed in a flow passage of the opening so as to open the opening only at the time of discharge of the content and to close the opening before and after the discharge of the content, and a cap member adapted to maintain the elastic opening-and-closing member in place in the opening in the button body.

### BACKGROUND ART

A manual spray pump is extensively used in bathroom products and cosmetics containers, which are adapted to discharge content such as liquid, emulsion or oil in a predetermined amount each time, owing to the convenience thereof. Particularly, since a manual spray pump is able to easily discharge content contained in a container in a predetermined amount each time at the time of use, it is extensively used, and technologies relating thereto are being steadily developed.

A conventional manual spray pump includes, as main components thereof, a housing defining the appearance of the spray pump, a closure adapted to mount the housing on a container, a stem communicating with an outlet of a button and being moved vertically along the housing, a shaft adapted to guide vertical movement of the stem and to connect the stem to the button, a housing cap adapted to guide vertical movement of the shaft and to seal the internal space in the housing from the outside, a piston adapted to be moved vertically in the inner surface of the housing in the state of being mounted on the stem, a compression spring mounted on a lower portion of the inner surface of the housing, and an elastic opening-and-closing member for opening and closing an introduction opening in the lower end of the housing.

However, such a conventional manual spray pump is unfavorable from a sanitary point of view because content residue remains at an outlet of a button after pumping. In addition, such a conventional manual spray pump has a problem whereby content having a low viscosity flows down or solidifies and blocks the outlet.

Although various structures have been developed in order to solve the above problems, a manual spray pump capable of offering a satisfactory solution has not still been developed. Accordingly, there is a substantial need to provide a technology capable of fundamentally solving the above problems.

### DISCLOSURE

### Technical Problem

Therefore, it is an object of the present invention to solve the above-mentioned problems associated with conventional technologies and technical problems which have been presented in the past.

Specifically, it is the object of the present invention to provide a manual spray pump, which is provided with a self-sealing nozzle adapted to open only at the time of pumping, thereby making it possible to prevent residue from remaining at an outlet after pumping and to prevent the content from solidifying or denaturing in the pump.

### Technical Solution

In order to accomplish the above objects, a manual spray pump according to the present invention is operated in such a manner that a manual button having a nozzle is pressed downwards to discharge a predetermined amount of content and then a passage in the nozzle is closed to seal the content, the manual button including a button body coupled to a pump body so as to communicate with a flow passage of the pump body, the button body having an opening formed in an outer surface of a portion thereof, the opening communicating with the flow passage and with an outside, an elastic opening-and-closing member disposed in a flow passage of the opening so as to open the opening only at the time of discharge of the content and to close the opening before and after the discharge of the content, and a cap member adapted to maintain the elastic opening-and-closing member in place in the opening in the button body.

In the manual spray pump according to the present invention, which is constructed to have the above structure, when the button is pushed in order to pump the content (hereinafter referred to as a ‘push mode’), the elastic opening-and-closing member is opened by the extrusion pressure in the pump body and the content is thus discharged. In contrast, when the force applied to the button is released (hereinafter referred to as a ‘release mode’), the nozzle is closed by virtue of the restoring force of the elastic opening-and-closing member.

Accordingly, by virtue of the elastic opening-and-closing member having the self-sealing performance, the content that remains in the nozzle after pumping is not exposed to the outside of the nozzle. Consequently, it is possible to efficiently prevent the content such as oil having a low viscosity from flowing down from the outlet of the nozzle or from solidifying and clogging the outlet of the nozzle. In addition, it is possible to prevent the content in the container from solidifying or denaturing due to oxidation or the like.

In the manual spray pump according to the present invention, not only conventional pumping structures that are known in the prior art but also pumping structures that may be developed in the future may be applied as long as the pump body is able to be manually operated and to discharge the content in a push mode.

In an illustrative embodiment, the pump body may include:

(a) a housing defining an appearance of the spray pump,

(b) a housing cap adapted to guide vertical movement of a shaft, the housing cap connecting the housing to a closure and sealing an internal space in the housing from an outside,

(c) the closure coupled to an outer surface of an upper portion of the housing cap via the housing cap so as to mount the housing on a container containing the content, the closure being integrally formed with the housing cap,

(d) a stem having a horizontal passage communicating with an internal space in the housing and a vertical passage communicating with the horizontal passage, the stem being connected to a lower end of the manual button and being moved vertically,

(e) the shaft fastened to an outer surface of the stem so as to be moved vertically along an inner surface of the housing cap,

(f) a piston mounted on a lower portion of the stem, the piston being moved vertically along an inner surface of the housing so as to open and close the horizontal passage in the stem,

(g) a compression spring disposed between a lateral protrusion formed on a lateral surface of an upper end of the shaft and the housing cap so as to provide the shaft with restoring force during a pumping operation, and

(h) an opening-and-closing member disposed in a lower portion of an internal space in the housing, the opening-and-closing member being moved vertically by means of a lower end of the stem so as to open and close a lower introduction opening in the housing during a pumping operation.

In an illustrative embodiment, the button body may include:

an extension coupler extending downwards from an inner surface of an upper end of the button body so as to communicate with the flow passage in the pump body,

a through hole formed through a lateral wall of the extension coupler, and

a button housing defining an appearance of the button body.

In this structure, the extension coupler of the pump body may be coupled, for example, to the stem of the pump body so as to communicate with the flow passage, and the through hole formed through the lateral wall of the extension coupler may communicate with the nozzle.

In an illustrative embodiment, the cap member may include:

a first cap defining therein a flow passage through which the content flows, the first cap having a first hollow passage to maintain the elastic opening-and-closing member in place, and

a second cap mounted on an outer end of the first cap in a state in which the elastic opening-and-closing member is disposed in the first cap, the second cap having a second hollow passage.

The first cap and the second cap may allow the elastic opening-and-closing member to be fitted thereinto in a substantial self-sealing state and may provide a flow passage for the content.

In an illustrative embodiment, the elastic opening-and-closing member may include:

a bar-shaped elastic body disposed and held in the first passage in the first cap, and

an elastic opening and closing portion formed on one end of the elastic body so as to elastically open and close the first passage at the outer end of the first cap.

In this structure, the first passage in the first cap may be provided with a first hollow portion and a second hollow portion in that order toward an outside from an inside of the button body, the first hollow portion having an inner diameter larger than an inner diameter of the second hollow portion such that a stepped portion is formed at a boundary area therebetween.

In this regard, the elastic body may be provided with a wedge-shaped coupling portion that engages with the stepped portion of the first cap and is thus held thereat. The elastic body may have an outer diameter smaller than an inner diameter of the second hollow portion, and the elastic opening and closing portion may have an outer diameter larger than the inner diameter of the second hollow portion.

In order to facilitate discharge of the content at the time of pumping, a tapered portion, which is gradually increased in inner diameter, may be formed on a region of the second hollow portion with which the elastic opening and closing portion is brought into contact.

In the manual spray pump, the elastic opening and closing portion may be externally deformed in at least a portion thereof due to the force used to extrude the content during a pumping operation, thereby partially opening the second hollow portion, whereas the elastic opening and closing portion may close the second hollow portion by virtue of the restoring force thereof after the pumping operation.

The elastic opening-and-closing member is not limited to a specific material as long as the material provides the elastic restoring force required for the above-mentioned deformation for opening and closing and does not permit denaturation of the content caused by the external environment. The material may be, for example, a rubber material or a silicone material. Examples of the rubber material may include natural rubber, SBR, NBR, BR and the like. Among these, NBR is particularly preferred.

### Advantageous Effects

As is apparent from the above description, since the manual spray pump according to the present invention is provided with a self-sealing nozzle, which is opened only at the time of pumping, there are effects of preventing residue from remaining at an outlet after pumping and of preventing the content from solidifying or denaturing in the pump.

### DESCRIPTION OF DRAWINGS

FIG. 1 is a vertical cross-sectional view of a manual spray pump according to an embodiment of the present invention; and

FIG. 2 is a fragmentary enlarged cross-sectional view illustrating the operation of a nozzle of a manual button of the manual spray pump shown in FIG. 1 at the time of pumping.

### BEST MODE

Hereinafter, an embodiment of the present invention will be described with reference to the accompanying drawings. The description of the embodiment is given only for illustrative purposes, and the scope of the present invention is not limited thereto.

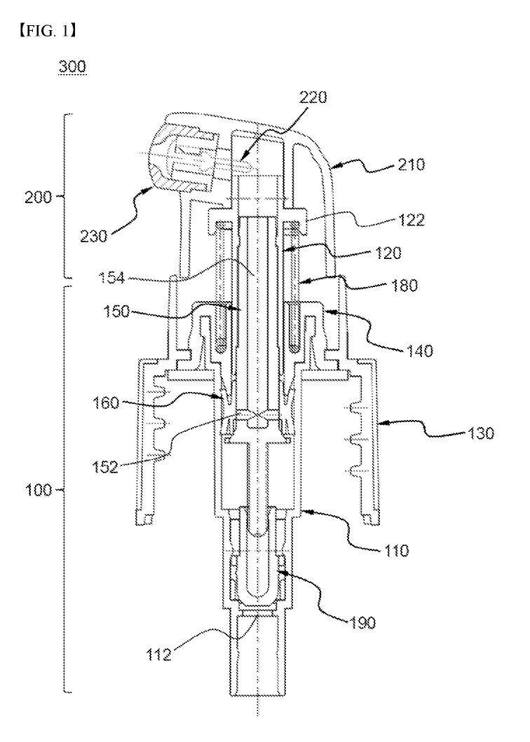

FIG. 1 is a schematic vertical cross-sectional view of a manual spray pump according to an embodiment of the present invention.

Referring to FIG. 1, the manual spray pump 300 includes a pump body 100 and a manual button 200 mounted on the pump body 100. The spray pump 300 is mounted on the opening of a container (not shown), which contains content therein, and is adapted to manually spray the content when necessary.

The pump body 110 includes a housing 110, which defines the appearance of the pump and is decreased in diameter in stages moving downwards; a housing cap 140, which connects the housing 110 to a closure 130 so as to guide the vertical movement of a shaft 120 and to seal the internal space in the housing 110 from the outside; the closure 130, which is integrally formed with the housing cap 140 and is fastened to the outer surface of the upper portion of the housing 110 by means of the housing cap 140 so as to fasten the housing 110 to a container (not shown) containing contents therein; a stem 150, which is connected to the lower end of the manual button 200 so as to be moved vertically and which includes a horizontal passage 152 communicating with the internal space in the housing 110 and a vertical passage 154 communicating with the horizontal passage 152; and a shaft 120 fastened to the outer surface of the stem 150 so as to be moved vertically along the inner surface of the housing cap 140.

A piston 160, which is adapted to open and close the vertical passage 152 in the stem 150 and to move along the inner surface of the housing 110, is positioned at a lower portion of the stem 150, and a compression spring 180, which is adapted to provide the shaft 120 with restoring force during a pumping operation, is disposed between a lateral protrusion 122 formed on the lateral surface of the upper end of the shaft 120 and the housing cap 140. A opening-and-closing member 190, which is adapted to open and close a lower introduction opening 112 in the housing 110 during a pumping operation, is disposed in a lower portion of the internal space in the housing 110, and the lower portion of the stem 150 is moved vertically through the open upper end of the opening-and-closing member 190.

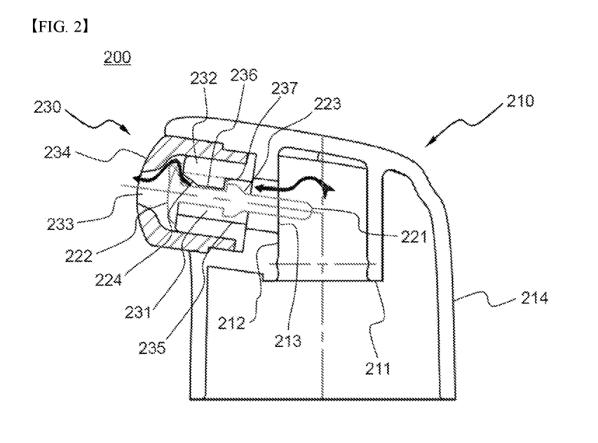

The manual button will be described with reference to FIGS. 1 and 2.

The manual button 200 includes a button body 210, an elastic opening-and-closing member 220 and a cap member 230.

The button body 210 is coupled to the pump body 100 so as to communicate with the flow passage in the pump body 100, and is provided in the outer surface thereof with an opening that communicates the flow passage with the outside.

The elastic opening-and-closing member 220 is disposed in the flow passage communicating with the opening so as to function to open the opening only at the time of spray action and to close the opening before and after the spray action.

The cap member 230 functions to maintain the elastic opening-and-closing member 220 in place in the opening in the button body 210.

The button body 210 includes an extension coupler 211 that extends downwards from the inner surface of the upper end of the button body 210 so as to communicate with the flow passage in the pump body 100, a through hole 213 formed through a lateral wall 212 of the extension coupler 211, and a button housing 214 defining the appearance of the button body 210.

The cap member 230 includes a first cap 232, which has a first hollow passage so as to define therein a flow passage for the content and to maintain the elastic opening-and-closing member 220 in place, and a second cap 234, which is coupled to the outer end of the first cap 232 in the state in which the elastic opening-and-closing member 220 is disposed in the first cap 232 and which has a second hollow passage 233 formed therein.

The first passage 231 in the first cap 232 and the second passage 233 in the second cap 234 substantially define the passage in the button body 210 in conjunction with the through hole 213 in the button body 210. Consequently, the content is discharged through the through hole 213, the first passage 231 and the second passage 233 in that order at the time of pumping.

The elastic opening-and-closing member 220 includes a bar-shaped elastic body 221, which is disposed and held in the first passage 231 in the first cap 232, and an elastic opening and closing portion 222, which is formed on one end of the elastic body 221 and is disposed at the outer end of the first cap 232 so as to elastically open and close the first passage 231. Although the other end of the elastic body 221 is illustrated in the drawing as extending to the center of the extension coupler 211, the present invention is not limited to the structure.

The first passage 231 in the first cap 232 is provided with a first hollow portion 235 and a second hollow portion 236 in that order toward the outside from the inside of the button body 210. Here, the first hollow portion 235 has an inner diameter larger than an inner diameter of the second hollow portion 236 such that a stepped portion 237 is formed at the boundary area therebetween.

The elastic body 221 is provided with a wedge-shaped coupling portion 223 that engages with the stepped portion 237 of the first cap 232 and is thus held thereat. Since the coupling portion 223 has an outer tapered surface that is tapered toward the center of the button body 210, it is easy to fit and assemble the elastic opening-and-closing member 220 into the button body 210 from the outside, and it is possible to assist the elastic opening-and-closing member 220 in being held in place by the first cap 232 after the elastic opening-and-closing member 220 is first assembled.

The outer diameter of the elastic body 221 is smaller than the inner diameter of the second hollow portion 236, and the outer diameter of the elastic opening and closing portion 220 is larger than the inner diameter of the second hollow portion 236. Here, because the first hollow portion 235 and the second hollow portion 236 are not positioned along the same axis, the elastic body 221, which is fitted into the second hollow portion 236 along the same axis, defines, in conjunction with the first hollow portion 235, surplus space through which the contents may flow. The conditions relating to the relative size of the components do not need to be limited to certain numerical values. As long as the components are configured to have such sizes as to provide a space through which the content flows while allowing the elastic opening-and-closing member 220 to be fitted into the first cap 232, there is no limit as to the sizes of the components.

A tapered portion 224, which is gradually increased in inner diameter, is formed on the region of the second hollow portion 236 with which the elastic opening and closing portion 222 is brought into contact.

Due to the force used to extrude the content, the elastic opening and closing portion 222 is externally deformed in at least a portion thereof, at which the tapered portion 224 is positioned, at the time of pumping, thereby partially opening the second hollow portion 236, as illustrated in FIG. 2. In contrast, the elastic opening and closing portion 222 closes the second hollow portion 236 by virtue of the restoring force thereof after the pumping, as illustrated in FIG. 1.

In the manual spray pump 300 according to the embodiment of the present invention, the manual button 200 may be assembled, for example, in such a way as to mount the first cap 232 on the button body 210, to fit the elastic opening-and-closing member 220 into the first cap 232 so as to be positioned in place and to mount the second cap 234 on the first cap 232. However, it goes without saying that this assembly order may be changed. For example, it may be possible to assemble the first cap 232 and the second cap 234 after positioning the elastic opening-and-closing member 220 in place in the button body 210.

Those skilled in the art will appreciate that various applications and modifications are possible based on the above disclosure.

1. A manual spray pump, which is operated in such a manner that a manual button having a nozzle is pressed downwards to discharge a predetermined amount of content and then a passage in the nozzle is closed to seal the content, the manual button comprising:
a button body coupled to a pump body so as to communicate with a flow passage of the pump body, the button body having an opening formed in an outer surface of a portion thereof, the opening communicating with the flow passage and with an outside;
an elastic opening-and-closing member disposed in a flow passage of the opening so as to open the opening only at a time of discharge of the content and to close the opening before and after the discharge of the content; and
a cap member adapted to maintain the elastic opening-and-closing member in place in the opening in the button body.

2. The manual spray pump according to claim 1, wherein the pump body comprises:
(a) a housing defining an appearance of the spray pump;
(b) a housing cap adapted to guide vertical movement of a shaft, the housing cap connecting the housing to a closure and sealing an internal space in the housing from an outside;
(c) the closure coupled to an outer surface of an upper portion of the housing cap via the housing cap so as to mount the housing on a container containing the content, the closure being integrally formed with the housing cap;
(d) a stem having a horizontal passage communicating with an internal space in the housing and a vertical passage communicating with the horizontal passage, the stem being connected to a lower end of the manual button and being moved vertically;
(e) the shaft fastened to an outer surface of the stem so as to be moved vertically along an inner surface of the housing cap;
(f) a piston mounted on a lower portion of the stem, the piston being moved vertically along an inner surface of the housing so as to open and close the horizontal passage in the stem;
(g) a compression spring disposed between a lateral protrusion formed on a lateral surface of an upper end of the shaft and the housing cap so as to provide the shaft with restoring force during a pumping operation; and
(h) an opening-and-closing member disposed in a lower portion of an internal space in the housing, the opening-and-closing member being moved vertically by means of a lower end of the stem so as to open and close a lower introduction opening in the housing during a pumping operation.

3. The manual spray pump according to claim 1, wherein the button body comprises:
an extension coupler extending downwards from an inner surface of an upper end of the button body so as to communicate with the flow passage in the pump body;
a through hole formed through a lateral wall of the extension coupler; and
a button housing defining an appearance of the button body.

4. The manual spray pump according to claim 1, wherein the cap member comprises:
a first cap defining therein a first flow passage through which the content flows, the first cap having therein a first hollow passage to maintain the elastic opening-and-closing member in place; and
a second cap mounted on an outer end of the first cap in a state in which the elastic opening-and-closing member is disposed in the first cap, the second cap having therein a second hollow passage.

5. The manual spray pump according to claim 4, wherein the elastic opening-and-closing member comprises:
a bar-shaped elastic body disposed and held in the first passage in the first cap; and
an elastic opening and closing portion formed on one end of the elastic body so as to elastically open and close the first passage at the outer end of the first cap.

6. The manual spray pump according to claim 5, wherein the first passage in the first cap is provided with a first hollow portion and a second hollow portion in that order toward an outside from an inside of the button body, the first hollow portion having an inner diameter larger than an inner diameter of the second hollow portion such that a stepped portion is formed at a boundary area therebetween,
wherein the elastic body is provided with a wedge-shaped coupling portion that engages with the stepped portion of the first cap and is thus held thereat, and
wherein the elastic body has an outer diameter smaller than an inner diameter of the second hollow portion, and the elastic opening and closing portion has an outer diameter larger than the inner diameter of the second hollow portion.

7. The manual spray pump according to claim 5, wherein a tapered portion, which is gradually increased in inner diameter, is formed on a region of the second hollow portion with which the elastic opening and closing portion is brought into contact.

8. The manual spray pump according to claim 5, wherein the elastic opening and closing portion is externally deformed in at least a portion thereof due to the force used to extrude the content during a pumping operation, thereby partially opening the second hollow portion, whereas the elastic opening and closing portion closes the second hollow portion by virtue of restoring force thereof after the pumping operation.

9. The manual spray pump according to claim 1, wherein the elastic opening-and-closing member is made of a rubber material or a silicone material.
